(19) United States
(12) Patent Application Publication
(10) Pub. No.: US 2018/0224927 A1
(43) Pub. Date: Aug. 9, 2018

(54) POSITIONING APPARATUS AND METHOD

(71) Applicant: HTC CORPORATION, Taoyuan City (TW)

(72) Inventor: Chen-Si DAI, TAOYUAN CITY (TW)

(21) Appl. No.: 15/874,022

(22) Filed: Jan. 18, 2018

Related U.S. Application Data
(60) Provisional application No. 62/447,453, filed on Jan. 18, 2017.

(51) Int. Cl. G06F 3/01; G01B 21/16

(52) U.S. Cl. CPC G06F 3/011; G01B 21/16

(57) ABSTRACT

A positioning apparatus and method are provided. The positioning apparatus receives a plurality of inertial measurement values generated by an inertial measurement unit at a plurality of time points respectively, wherein the time points are within a time interval and the inertial measurement unit is included in a trackable apparatus. The positioning apparatus determines that the inertial measurement values conform to one of the following two conditions: (i) a frequency of the inertial measurement values conforms to a first predetermined condition and (ii) a signed magnitude of each of the inertial measurement values conforms to a second predetermined condition. After determining that the inertial measurement values conform to one of the two conditions, the positioning apparatus adjusts at least one original positioning location of the trackable apparatus within the time interval to at least one rectified positioning location according to at least one of the inertial measurement values.

This application claims the benefit of U.S. Provisional Application Ser. No. 62/447,453 filed on Jan. 18, 2017, which are hereby incorporated by reference in its entirety.

### CROSS-REFERENCES TO RELATED APPLICATIONS

Not applicable.

### BACKGROUND OF THE INVENTION

### Field of the Invention

The present invention relates to a positioning apparatus and method. More particularly, the present invention relates to a positioning apparatus and method that determines a location of a trackable apparatus with reference to inertial measurement data.

### Descriptions of the Related Art

With the rapid development of science and technology, many types of positioning technologies are available for different fields and an important issue of which is to determine a position precisely. An exemplary field that requires positioning technology is the reality technology, which is rather popular in recent years and is a kind of technology that establishes a virtual environment or provides a virtual-physical integration/virtual-physical mixture environment to improve user experiences, including the Virtual Reality (VR) technology, the Augmented Reality (AR) technology, the Mixed Reality (MR) technology, and the Cinematic Reality (CR) technology. For these reality technologies, it is extremely important to correctly and rapidly determine the location of a trackable apparatus (e.g., a Head-Mounted Display (HMD), a controller, and a tracker) in a physical space in order to simulate the location in a virtual space.

Taking the reality technology as an example, many positioning technologies (e.g., the lighthouse positioning technology, the constellation positioning technology) are currently available, which, however, all have drawbacks. When the inertia of the trackable apparatus changes instantly or the inertia of the environment where the trackable apparatus is located changes instantly, these conventional technologies cannot react to the change(s) to achieve precise positioning. Taking the VR shooting games as an example, the trackable apparatus that has to be located/positioned precisely is a game gun operated by the user. When the user pulls the trigger of the game gun, the inertia of the game gun will change instantly due to mechanism vibration. With the mechanism vibration, the conventional positioning technologies cannot determine the location of the game gun accurately. Another exemplary scenario is the user uses a reality related product on a moving vehicle. The inertia of the environment where the trackable apparatus is located will change instantly when the vehicle is speeding up or making a turn, which results in the positioning of the conventional positioning technologies being inaccurate.

Accordingly, to determine the location of an object precisely when the object changes in some way or when the environment where the object is located changes (e.g., in various reality technologies, when the inertia of the trackable apparatus changes instantly or the inertia of the environment where the trackable apparatus is located changes instantly) is a critical technical problem to be solved.

### SUMMARY OF THE INVENTION

An objective of the present invention is to provide a positioning apparatus. The positioning apparatus comprises a receiving interface and a processor, wherein the receiving interface is electrically connected to the receiving interface. The receiving interface receives a plurality of inertial measurement values, wherein the inertia measurement values are generated by an inertial measurement unit included in a trackable apparatus at a plurality of time points within a time interval respectively. The processor determines that the inertial measurement values conform to one of the following two conditions: (i) a frequency of the inertial measurement values conforms to a first predetermined condition and (ii) a signed magnitude of each of the inertial measurement values conforms to a second predetermined condition. After determining that the inertial measurement values conform to one of the two conditions, the processor adjusts at least one original positioning location of the trackable apparatus within the time interval to at least one rectified positioning location according to at least one of the inertial measurement values.

Another objective of the present invention is to provide a positioning method, which is adapted for an electronic computing apparatus. The positioning method comprises the following steps: (a) receiving a plurality of inertial measurement values, wherein the inertial measurement values are generated by an inertial measurement unit included in a trackable apparatus at a plurality of time points within a time interval respectively, (b) determining that the inertial measurement values conform to one of the following two conditions: (i) a frequency of the inertial measurement values conforms to a first predetermined condition and (ii) a signed magnitude of each of the inertial measurement values conforms to a second predetermined condition, and (c) adjusting at least one original positioning location of the trackable apparatus within the time interval to at least one rectified positioning location according to at least one of the inertial measurement values after determining that the inertial measurement values conform to one of the two conditions.

The positioning technology (at least including the aforementioned apparatus and method) provided by the present invention is adapted for a system having the positioning function. When the system operates, the positioning technology provided by the present invention detects whether the inertia of a trackable apparatus changes instantly or whether the inertia of the environment where the trackable apparatus is located changes instantly by determining whether a frequency of a plurality of inertial measurement data generated by an inertial measurement unit included in the trackable apparatus conforms to a first predetermined condition or whether a signed magnitude of each of the inertial measurement data conforms to a second predetermined condition. After determining that the inertial measurement data within a time interval conform to the first predetermined condition or the second predetermined condition, the positioning technology provided by the present invention adjusts at least one original positioning location of the trackable apparatus to at least one rectified positioning location according to at least one of the inertial measurement data. By the aforementioned approach, precise positioning can be achieved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a system 1 according to a first embodiment, a second embodiment, and a third embodiment; and

FIG. 2 depicts a flowchart of a positioning method according to a fourth embodiment.

### DESCRIPTION OF THE PREFERRED EMBODIMENT

In the following description, the positioning apparatus and method provided by the present invention will be explained with reference to embodiments thereof. However, these embodiments are not intended to limit the present invention to any environment, applications, or implementations described in these embodiments. Therefore, descriptions of these embodiments is only for purpose of illustration rather than to limit the scope of the present invention. It should be appreciated that, in the following embodiments and the attached drawings, elements unrelated to the present invention are omitted from depiction. In addition, dimensions of elements as well as dimensional relationships between individual elements in the attached drawings are described only for purpose of illustration but not to limit the scope of the present invention.

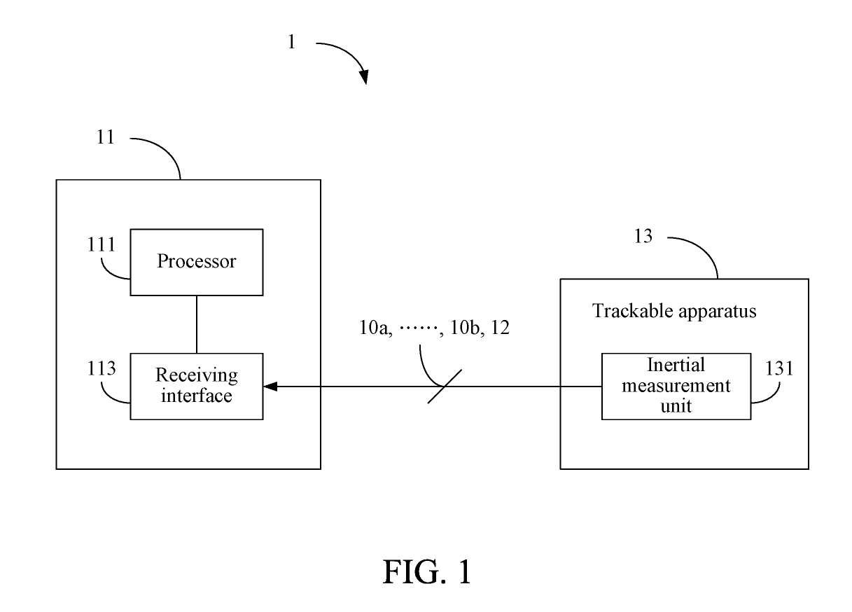

A first embodiment of the present invention is a system 1 having the positioning function, wherein a schematic view of which is depicted in FIG. 1. The system 1 comprises a positioning apparatus 11 and a trackable apparatus 13, wherein the positioning apparatus 11 and the trackable apparatus 13 may be connected in a wired or wireless way to transmit/receive data. In some embodiments, the system 1 may be implemented as a reality system capable of establishing a virtual environment or providing a virtual-physical integration/virtual-physical mixture environment to improve user experiences, e.g., a Virtual Reality (VR) system, an Augmented Reality (AR) system, a Mixed Reality (MR) system, and a Cinematic Reality (CR) system.

The positioning apparatus 11 comprises a processor 111 and a receiving interface 113, wherein the processor 111 is electrically connected to the receiving interface 113. The processor 111 may be any of central processing units (CPUs), microprocessors, microcontroller units (MCUs), or other computing devices well known to those of ordinary skill in the art. The receiving interface 113 may be any of various wired or wireless interfaces capable of receiving signals and data. For example, the positioning apparatus 11 may be implemented as a chip, a Head-Mounted Display (HMD), a controller, a tracker that can be integrated with other auxiliary apparatuses, a game console, a server, a personal computer, a notebook computer, or other apparatus capable of computing, but it is not limited thereto.

The location of the trackable apparatus 13 may be determined. The trackable apparatus 13 comprises an inertial measurement unit 131. In some embodiments, the inertial measurement unit 131 may comprise a G-sensor and/or a Gyro. In some embodiments, the inertial measurement unit 131 may comprise an element that generates inertial measurement values of one single axis. For example, the trackable apparatus 13 may be implemented as a Head-Mounted Display, a controller, a tracker that can be integrated with other auxiliary apparatuses, or other apparatus whose location can be determined, but it is not limited thereto.

Please note that each of the positioning apparatus 11 and the trackable apparatus 13 is an independent hardware in this embodiment. Nevertheless, the positioning apparatus 11 and the trackable apparatus 13 may be integrated into the same hardware in other embodiments.

When the system 1 operates, the positioning apparatus 11 determines the location of the trackable apparatus 13 timely (e.g., periodically). When there is a need in determining the location, the positioning apparatus 11 obtains at least one original positioning location of the trackable apparatus 13 (e.g., obtaining the original positioning location of the trackable apparatus 13 by a known positioning technology) and then determines at least one rectified positioning location of the trackable apparatus 13 according to at least one piece of inertial measurement data generated by the inertial measurement unit 131 (which will be described in detail later). It shall be appreciated that the present invention does not focus on which positioning technology is adopted by the positioning apparatus 11 to obtain the original positioning location of the trackable apparatus 13 as well as how the adopted positioning technology operates. Therefore, apparatuses and elements required by the adopted positioning technology as well as the specific operations of the adopted positioning technology will be not further described herein.

When the system 1 operates, the inertial measurement unit 131 generates inertial measurement data in response to actions of the trackable apparatus 13 (e.g., the trackable apparatus 13 is moved by the user, a control key/operational key of the trackable apparatus 13 is pressed by the user) and the receiving interface 113 of the positioning apparatus 11 receives the inertial measurement data generated by the inertial measurement unit 131. The inertial measurement unit 131 generates a piece of inertial measurement data at each time point, wherein each piece of inertial measurement data may comprise one or more inertial measurement values. Specifically, when the inertial measurement unit 131 comprises an element that generates inertial measurement values of only one single axis, each piece of inertial measurement data comprises one inertial measurement value. When the inertial measurement unit 131 comprises a G-sensor, each piece of inertial measurement data comprises three inertial measurement values including an acceleration value of a first axis (e.g., X-axis), an acceleration value of a second axis (e.g., Y-axis), and an acceleration value of a third axis (e.g., Z-axis), wherein the first axis, the second axis, and the third axis are perpendicular to each other. When the inertial measurement unit 131 comprises a Gyro, each piece of inertial measurement data comprises three inertial measurement values including an angular velocity value of a first axis (e.g., X-axis), an angular velocity value of a second axis (e.g., Y-axis), and an angular velocity value of a third axis (e.g., Z-axis), wherein the first axis, the second axis, and the third axis are perpendicular to each other. When the inertial measurement unit 131 comprises both the G-sensor and the Gyro, each piece of inertial measurement data comprises six inertial measurement values, which will not be further described herein.

As described previously, the positioning apparatus 11 determines the location of the trackable apparatus 13 timely (e.g., periodically). When there is a need in determining the location, the positioning apparatus 11 obtains at least one original positioning location of the trackable apparatus 13 and then determines at least one rectified positioning location of the trackable apparatus 13 according to at least one piece of inertial measurement data generated by the inertial measurement unit 131. Herein, it is assumed that the receiving interface 113 of the positioning apparatus 11 receives a plurality of inertial measurement values 10a, . . . , 10b (e.g., acceleration values of the X-axis) generated by the inertial measurement unit 131 at a plurality of first time points within a time interval respectively. Please note that the first time points are different time points within the time interval. Next, the processor 111 evaluates whether to adjust a plurality of original positioning locations of the trackable apparatus 13 at the first time points according to the inertial measurement values 10a, . . . , 10b, wherein each of the first time points corresponds to one of the original positioning locations.

Specifically, the processor 111 determines whether the inertial measurement values 10a, . . . , 10b conform to one of the following two conditions: (i) a frequency of the inertial measurement values 10a, . . . , 10b conforms to a first predetermined condition and (ii) a signed magnitude of each of the inertial measurement values 10a, . . . , 10b conforms to a second predetermined condition. If the processor 111 determines that the inertial measurement values 10a, . . . , 10b do not conform to any of the aforementioned two conditions, the processor 111 will not adjust the original positioning locations of the trackable apparatus 13 at the first time points. If the processor 111 determines that the inertial measurement values 10a, . . . , 10b conform to one of the aforementioned two conditions, it means that the inertia of the trackable apparatus 13 or the inertia of the environment where the trackable apparatus 13 is located has a certain characteristic within the time interval. After the processor 111 determines that the inertial measurement values 10a, . . . , 10b conform to one of the aforementioned two conditions, the processor 111 adjusts at least one of the original positioning locations of the trackable apparatus 13 within the time interval to at least one rectified positioning location according to at least one of the inertial measurement values 10a, . . . , 10b (e.g., the values that are negative to the inertial measurement values 10a, . . . , 10b).

For example, the processor 111 may adjust each of the at least one original positioning location by the following operations: (a) representing the original positioning location by a first matrix, (b) generating a rotation matrix by the inertial measurement value (one of the inertial measurement values 10a, . . . , 10b) corresponding to the original positioning location, and (c) generating a second matrix by multiplying the first matrix by the rotation matrix, wherein the second matrix represents the rectified positioning location corresponding to the original positioning location. Each of the at least one first matrix, each of the at least one rotation matrix, and each of the at least one second matrix belong to a quaternion coordinate system.

Herein, it is assumed that the system 1 operates continuously and an inertia measurement value 12 generated by the inertial measurement unit 131 at a second time point subsequent to the first time points (e.g., right after the last one of the first time points) is received by the receiving interface 113. The processor 111 determines whether a part of the inertia measurement values 10a, . . . , 10b (e.g., the last several inertial measurement values) together with the inertial measurement value 12 still conform to one of the two conditions. In other words, the processor 111 determines whether the inertia of the trackable apparatus 13 or the inertia of the environment where the trackable apparatus 13 is located still have the certain characteristic at the time point subsequent to the time interval. Please note that if the processor 111 previously determines that the frequency of the inertia measurement values 10a, . . . , 10b conforms to the first predetermined condition, the processor 111 now determines whether the frequency of the part of the inertia measurement values 10a, . . . , 10b and the inertial measurement value 12 still conform to the first predetermined condition. If the processor 111 previously determines that a signed magnitude of each of the inertial measurement values 10a, . . . , 10b conforms to the second predetermined condition, the processor 111 now determines whether a signed magnitude of each of the part of the inertial measurement values 10a, . . . , 10b and the inertial measurement value 12 still conforms to the second predetermined condition. If the processor 111 determines that the part of the inertial measurement values 10a, . . . , 10b and the inertial measurement value 12 still conforms to one of the two conditions, the processor 111 will adjust an original positioning location of the trackable apparatus 13 at the second time point to a rectified positioning location of the trackable apparatus 13 at the second time point according to the inertial measurement value 12.

Please note that the above description is based on the example that the inertial measurement unit 131 generates inertial measurement values of one single axis (e.g., each of the inertial measurement values 10a, . . . , 10b, 12 is an acceleration value of the X-axis). Based on the above description, those of ordinary skill in the art shall appreciate that if the inertial measurement unit 131 is able to generate inertial measurement values of multiple axes at a time point, the processor 111 will analyze the inertial measurement values of each of the axes individually and then determine whether the inertial measurement values of each of the axes conform to one of the aforementioned two conditions. If the inertial measurement values of any axis/axes conform to one of the aforementioned two conditions, the processor 111 will adjust the original positioning location(s) of that axis/those axes into the rectified positioning location(s) according to the inertial measurement value(s) corresponding to that axis/those axes.

According to the above descriptions, when the system 1 operates, the positioning apparatus 11 analyzes whether a plurality of pieces of inertial measurement data generated by the inertial measurement unit 131 when the trackable apparatus 13 operates within a time interval conform to one of the aforesaid two conditions. If the inertial measurement data conforms to one of the aforementioned two conditions, the positioning apparatus 11 adjusts at least one original positioning location of the trackable apparatus 13 within the time interval to at least one rectified positioning location according to at least one of the inertial measurement values. By determining whether the inertial measurement data generated by the inertial measurement unit 131 when the trackable apparatus 13 operates conforms to one of the aforementioned two conditions, the positioning apparatus 11 can adjust the positioning location in response to the instant change of the inertia of the trackable apparatus 13 or the instant change of the inertial of the environment where the trackable apparatus 13 is located. Thereby, precise positioning can be achieved.

Please refer to FIG. 1 for a second embodiment of the present invention. In the second embodiment, the operations that can be executed, the functions that can be had, and the technical effects that can achieved by the positioning apparatus 11 are generally the same as those described in the first embodiment. In this embodiment, the trackable apparatus 13 will generate mechanism vibration suddenly at some point. The positioning apparatus 11 can determine the mechanism vibration according to the adopted first predetermined condition and then adjust the original positioning location of the trackable apparatus 13 into the rectified positioning location according to the inertial measurement values. The following description will only focus on the differences between the second embodiment and the first embodiment.

As described in the above paragraph, in this embodiment, the trackable apparatus 13 will generate mechanism vibration suddenly at some point (e.g., within a time period right after the user presses the control key/operational key of the trackable apparatus 13). When the trackable apparatus 13 generates mechanism vibration suddenly, the positioning technology adopted by the positioning apparatus 11 cannot precisely determine the location of the trackable apparatus 13 (i.e., the aforementioned original positioning location is not precise). In a specific example, the trackable apparatus 13 may be a game gun in the virtual shooting game (i.e., the trackable apparatus 13 and the game gun are integrated into the same hardware). Within a time period right after the user presses the control key/operational key of the trackable apparatus 13 (e.g., pulls the trigger), the trackable apparatus 13 generates mechanism vibration so that the location of the trackable apparatus 13 cannot be determined accurately. In this specific example, the positioning apparatus 11 and the trackable apparatus 13 may each be an independent hardware. It is also feasible that the positioning apparatus 11 and the trackable apparatus 13 are integrated into the same hardware (i.e., both the positioning apparatus 11 and the trackable apparatus 13 are integrated into the same hardware with the game gun). In another specific example of the virtual shooting game, the trackable apparatus 13 may be implemented as a tracker and be installed on a game gun. When the user presses the control key/operational key of the game gun, the trackable apparatus 13 also generates mechanism vibration and, hence, the location of the trackable apparatus 13 cannot be determined accurately. Similarly, in this specific example, the positioning apparatus 11 and the trackable apparatus 13 may each be an independent hardware. It is also feasible that the positioning apparatus 11 and the trackable apparatus 13 are integrated into the same hardware (i.e., both the positioning apparatus 11 and the trackable apparatus 13 are integrated into the same hardware with the tracker).

It shall be appreciated that the characteristic of the mechanism vibration is of a high frequency. Therefore, when the trackable apparatus 13 generates mechanism vibration, a frequency of a plurality of inertial measurement values generated by the inertial measurement unit 131 included in the trackable apparatus 13 is greater than a threshold. In other words, when a frequency of the plurality of inertial measurement values received by the receiving interface 113 of the positioning apparatus 11 is greater than the threshold, it means that the trackable apparatus 13 generates mechanism vibration when the inertial measurement unit 131 generates the inertial measurement values.

For ease of description, a specific example is described herein. In this specific example, the frequency that the inertial measurement unit 131 generates the inertial measurement values is a multiple of a frequency of the mechanism vibration. Herein, it is assumed that the inertial measurement unit 131 generates the inertial measurement values 10a, . . . , 10b within 10 milliseconds and the signed magnitudes of the inertial measurement values 10a, . . . , 10b are respectively −4.99, +5.01, −5, +5.02, . . . , and −4.98. The processor 111 determines that the frequency of the inertial measurement values 10a, . . . , 10b is greater than the threshold. Since the processor 111 determines that the frequency of the inertial measurement values 10a, . . . , 10b is greater than the threshold, it means that the processor 111 has found that the trackable apparatus 13 generates mechanism vibration when the inertial measurement unit 131 generates the inertial measurement values 10a, . . . , 10b. Next, the processor 111 adjusts the corresponding original positioning location into the rectified positioning location according to negative values (i.e., +4.99, −5.01, +5, −5.02, . . . , and +4.98) of the inertial measurement values 10a, . . . , 10b.

Please note that if the frequency that the inertial measurement unit 131 generates the inertial measurement values is not a multiple of a frequency of the mechanism vibration, the processor 111 may determine whether the inertial measurement values have a regular pattern. If the inertial measurement values have a regular pattern, the processor 111 calculates a frequency according to the pattern and then determines whether the frequency is greater than the threshold. For example, the processor 111 may transform the inertial measurement values into a frequency domain by Discrete Fourier Transform (DFT) and then determine whether the transformed signals have a spike signal. If there is a spike signal, the frequency corresponding to the spike signal may be regarded as the frequency of the inertial measurement values. Then, the processor 111 further determines whether the frequency corresponding to the spike signal is greater than the threshold, and the following operations will not be further described.

From the above descriptions, it is understood that the positioning apparatus 11 can detect whether the trackable apparatus 13 has generated mechanism vibration by determining whether a frequency of a plurality of inertial measurement values is greater than a threshold. If it is detected that the trackable apparatus 13 has generated the mechanism vibration, the positioning apparatus 11 can adjust the positioning location of the trackable apparatus 13. Thereby, precise positioning can be achieved.

Please refer to FIG. 1 for a third embodiment of the present invention. In the third embodiment, the operations that can be executed, the functions that can be had, and the technical effects that can be achieved by the positioning apparatus 11 are generally the same as those described in the first embodiment. In this embodiment, the inertial of the environment where the trackable apparatus 13 is located will change suddenly and greatly at some point (For example, the system 1 is implemented as a reality system and the positioning apparatus 11 and the trackable apparatus 13 are implemented as a Head-Mounted Display. When the system 1 is used on a moving vehicle, the inertial of the environment where the trackable apparatus 13 is located will change instantly if the vehicle is speeding up or making a turn). The positioning apparatus 11 can determine such a change according to the adopted second predetermined condition and then adjust the original positioning location of the trackable apparatus 13 to the rectified positioning location according to the inertial measurement values. The following description will only focus on the difference between the third embodiment and the first embodiment.

In order to detect that the inertial of the environment where the trackable apparatus 13 is located has changed suddenly and greatly, the second predetermined condition may be set to be a signed magnitude of each of the inertial measurement values being greater than a first threshold or smaller than a second threshold. When the inertial measurement values received by the receiving interface 113 of the positioning apparatus 11 conform to the second predetermined condition, it means that the inertia of the environment where the trackable apparatus 13 is located changes greatly when the inertial measurement unit 131 generates these inertial measurement values.

For ease of description, in a specific example, it is assumed that the inertial measurement unit 131 generates inertial measurement values 10a, . . . , 10b within 10 seconds, wherein the signed magnitudes of the inertial measurement values 10a, . . . , 10b are respectively 100, 99.9, 100.2, 99.5, . . . , and 100.1. If the processor 111 of the positioning apparatus 11 determines that the signed magnitude of each of the inertial measurement values 10a, . . . , 10b is greater than the first threshold (e.g., 80), it means that the processor 111 has found that the inertia of the environment where the trackable apparatus 13 is located changes greatly when the inertial measurement unit 131 generates the inertial measurement values 10a, . . . , 10b. Next, the processor 111 adjusts the corresponding original positioning location into the rectified positioning location according to negative values (i.e., −100, −99.9, −100.2, −99.5, . . . , and −100.1) of the inertial measurement values 10a, . . . , 10b.

In another specific example, it is assumed that the inertial measurement unit 131 generates inertial measurement values 10a, . . . , 10b within 1 second, wherein the signed magnitudes of the inertial measurement values 10a, . . . , 10b are respectively −100, −99.9, −100.2, −99.5, . . . , and −100.1. If the processor 111 of the positioning apparatus 11 determines that the signed magnitude of each of the inertial measurement values 10a, . . . , 10b is smaller than the second threshold (e.g., −80), it means that the processor 111 has found that the inertia of the environment where the trackable apparatus 13 is located changes greatly when the inertial measurement unit 131 generates the inertial measurement values 10a, . . . , 10b. Similarly, the processor 111 adjusts the corresponding original positioning location to the rectified positioning location according to negative values (i.e., 100, 99.9, 100.2, 99.5, . . . , and 100.1) of the inertial measurement values 10a, . . . , 10b.

From the above descriptions, it is learned that by setting the second predetermined condition to be a signed magnitude of each of the inertial measurement values being greater than a first threshold or smaller than a second threshold, the positioning apparatus 11 can detect that the inertia of the environment where the trackable apparatus 13 is located changes greatly and then adjust the positioning location of the trackable apparatus 13. Thereby, precise positioning can be achieved.

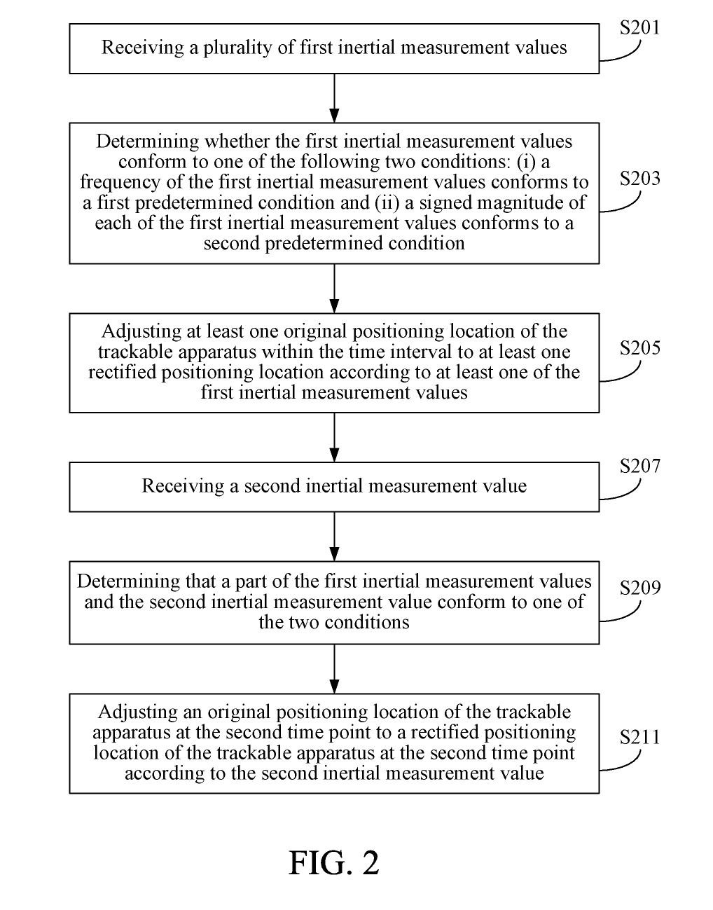

A fourth embodiment of the present invention is a positioning method and a flowchart of which is depicted in FIG. 2. The positioning method is adapted for an electronic computing apparatus (e.g., the positioning apparatus 11 of the first to the third embodiments). The electronic computing apparatus may be implemented as a chip, a game console, a server, a personal computer, a notebook computer, or other apparatus capable of computing. The electronic computing apparatus is used with a trackable apparatus, wherein the trackable apparatus comprises an inertial measurement unit. The positioning method can determine the location of the trackable apparatus. When the inertia of the trackable apparatus changes instantly or the inertia of the environment where the trackable apparatus is located changes instantly, the positioning method can still determine the location of the trackable apparatus accurately.

First, step S201 is executed by the electronic computing apparatus to receive a plurality of first inertial measurement values, wherein the first inertia measurement values are generated by the inertial measurement unit included in the trackable apparatus at a plurality of first time points within a time interval respectively. Next, step S203 is executed by the electronic computing apparatus to determine whether the first inertial measurement values conform to one of the following two conditions: (i) a frequency of the first inertial measurement values conforms to a first predetermined condition and (ii) a signed magnitude of each of the first inertial measurement values conforms to a second predetermined condition. Since the first inertial measurement values is determined to conform to one of the aforementioned two conditions, step S205 is then executed. In the step S205, the electronic computing apparatus adjusts at least one original positioning location of the trackable apparatus within the time interval to at least one rectified positioning location according to at least one of the first inertial measurement values.

Please note that each of the first inertial measurement values is an acceleration value in some embodiments. Yet, in some other embodiments, each of the first inertial measurement values is an angular velocity value.

In some embodiments, the step S205 adjusts each of the at least one original positioning location by the following steps: representing the original positioning location by a first matrix, generating a rotation matrix by the first inertial measurement value corresponding to the original positioning location, and generating a second matrix by multiplying the first matrix by the rotation matrix, wherein the second matrix represents the rectified positioning location corresponding to the original positioning location. Each of the at least one first matrix, each of the at least one rotation matrix, and each of the at least one second matrix belong to a quaternion coordinate system.

In some embodiments, the positioning method may further execute step S207, in which the electronic computing apparatus receives a second inertial measurement value generated by the inertial measurement unit at a second time point subsequent to the first time points. Next, in step S209, the electronic computing apparatus determines that a part of the first inertial measurement values and the second inertial measurement value conform to one of the two conditions. Please note that if it is determined that the frequency of the first inertial measurement values conform to the first predetermined condition in the step S203, the step S209 needs to determine that the frequency of the part of the first inertial measurement values and the second inertial measurement value conform to the first predetermined condition. If it is determined that the signed magnitude of each of the first inertial measurement values conforms to the second predetermined condition in the step S203, the step S209 needs to determine that the signed magnitude of each of the part of the first inertial measurement values and the second inertial measurement value conforms to the second predetermined condition. In response to the determination result of the step S209, the positioning method executes step S211 to adjust, by the electronic computing apparatus, an original positioning location of the trackable apparatus at the second time point to a rectified positioning location of the trackable apparatus at the second time point according to the second inertial measurement value.

As described previously, when the inertia of the trackable apparatus changes instantly or the inertia of the environment where the trackable apparatus is located changes instantly, the positioning method of this embodiment can still perform positioning accurately. In order to detect whether the trackable apparatus generates mechanism vibration, the first predetermined condition may be set to be the frequency of the first inertial measurement values being greater than a first threshold.

In order to detect whether the inertia of the environment where the trackable apparatus is located changes suddenly and greatly, the second predetermined condition may be set to be a signed magnitude of each of the first inertial measurement values being greater than a second threshold or smaller than a third threshold.

In addition to the aforementioned steps, the fourth embodiment can execute all the operations and steps, have the same functions, and deliver the same technical effects as set forth in the first to the third embodiments. How the fourth embodiment executes these operations and steps, has the same functions, and delivers the same technical effects as the first to the third embodiments will be readily appreciated by those of ordinary skill in the art based on the explanation of the first to the third embodiments, and thus will not be further described herein.

The positioning technology (at least including the aforementioned apparatus and method) provided by the present invention is adapted for a system having the positioning function. When the system operates, the positioning technology provided by the present invention detects whether the inertia of a trackable apparatus changes instantly or whether the inertia of the environment where the trackable apparatus is located changes instantly by determining whether a frequency of the inertial measurement data generated by the inertial measurement unit included in the trackable apparatus conforms to a first predetermined condition or whether a signed magnitude of each of the inertial measurement data conforms to a second predetermined condition. After determining that the inertial measurement data conform to the first predetermined condition or the second predetermined condition, the positioning technology provided by the present invention adjusts the original positioning location of the trackable apparatus to the rectified positioning location according to the inertial measurement data and, thereby, precise positioning can be achieved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A positioning apparatus, comprising:
a receiving interface, being configured to receive a plurality of first inertial measurement values, wherein the first inertia measurement values are generated by an inertial measurement unit included in a trackable apparatus at a plurality of first time points within a time interval respectively; and
a processor, being electrically connected to the receiving interface and configured to determine that the first inertial measurement values conform to one of the following two conditions: (i) a frequency of the first inertial measurement values conforms to a first predetermined condition and (ii) a signed magnitude of each of the first inertial measurement values conforms to a second predetermined condition,
wherein the processor adjusts at least one original positioning location of the trackable apparatus within the time interval to at least one rectified positioning location according to at least one of the first inertial measurement values after determining that the first inertial measurement values conform to one of the two conditions.

2. The positioning apparatus of claim 1, wherein the first predetermined condition is that the frequency of the first inertial measurement values is greater than a threshold.

3. The positioning apparatus of claim 1, wherein the second predetermined condition is that the signed magnitude of each of the first inertial measurement values is greater than a threshold.

4. The positioning apparatus of claim 1, wherein the second predetermined condition is that the signed magnitude of each of the first inertial measurement values is less than a threshold.

5. The positioning apparatus of claim 1, wherein the receiving interface further receives a second inertial measurement value, the second inertial measurement value is generated by the inertial measurement unit at a second time point subsequent to the first time points, the processor further determines that a part of the first inertial measurement values and the second inertial measurement value conform to one of the two conditions, and the processor further adjusts an original positioning location of the trackable apparatus at the second time point to a rectified positioning location of the trackable apparatus at the second time point according to the second inertial measurement value after determining that the part of the first inertial measurement values and the second inertial measurement value conform to one of the two conditions.

6. The positioning apparatus of claim 1, wherein the processor adjusts each of the at least one original positioning location by the following operations:
representing the original positioning location by a first matrix,
generating a rotation matrix by the first inertial measurement value corresponding to the original positioning location, and
generating a second matrix by multiplying the first matrix by the rotation matrix, wherein the second matrix represents the rectified positioning location corresponding to the original positioning location,
wherein each of the at least one first matrix, each of the at least one rotation matrix, and each of the at least one second matrix belong to a quaternion coordinate system.

7. The positioning apparatus of claim 1, wherein each of the first inertial measurement values is an acceleration value.

8. The positioning apparatus of claim 1, wherein each of the first inertial measurement values is an angular velocity value.

9. A positioning method, being adapted for an electronic computing apparatus and comprising the following steps:
(a) receiving a plurality of first inertial measurement values, wherein the first inertial measurement values are generated by an inertial measurement unit included in a trackable apparatus at a plurality of first time points within a time interval respectively;
(b) determining that the first inertial measurement values conform to one of the following two conditions: (i) a frequency of the first inertial measurement values conforms to a first predetermined condition and (ii) a signed magnitude of each of the first inertial measurement values conforms to a second predetermined condition; and
(c) adjusting at least one original positioning location of the trackable apparatus within the time interval to at least one rectified positioning location according to at least one of the first inertial measurement values after determining that the first inertial measurement values conform to one of the two conditions.

10. The positioning method of claim 9, wherein the first predetermined condition is that the frequency of the first inertial measurement values is greater than a threshold.

11. The positioning method of claim 9, wherein the second predetermined condition is that the signed magnitude of each of the first inertial measurement values is greater than a threshold.

12. The positioning method of claim 9, wherein the second predetermined condition is that the signed magnitude of each of the first inertial measurement values is less than a threshold.

13. The positioning method of claim 9, further comprising the following steps:
receiving a second inertial measurement value, wherein the second inertial measurement value is generated by the inertial measurement unit at a second time point subsequent to the first time points;
determining that a part of the first inertial measurement values and the second inertial measurement value conform to one of the two conditions; and
adjusting an original positioning location of the trackable apparatus at the second time point to a rectified positioning location of the trackable apparatus at the second time point according to the second inertial measurement value after determining that the part of the first inertial measurement values and the second inertial measurement value conform to one of the two conditions.

14. The positioning method of claim 9, wherein the step (c) adjusts each of the at least one original positioning location by the following steps:
representing the original positioning location by a first matrix;
generating a rotation matrix by the first inertial measurement value corresponding to the original positioning location; and
generating a second matrix by multiplying the first matrix by the rotation matrix, wherein the second matrix represents the rectified positioning location corresponding to the original positioning location,
wherein each of the at least one first matrix, each of the at least one rotation matrix, and each of the at least one second matrix belong to a quaternion coordinate system.

15. The positioning method of claim 9, wherein each of the first inertial measurement values is an acceleration value.

16. The positioning method of claim 9, wherein each of the first inertial measurement values is an angular velocity value.
